(19) United States
(12) Patent Application Publication
(10) Pub. No.: US 2007/0180384 A1
(43) Pub. Date: Aug. 2, 2007

(54) Method for selecting a list item and information or entertainment system, especially for motor vehicles

(76) Inventors: Demetrio Aiello, Zeitlam (DE); Nhu Nguyen Thien, Regensburg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/589,649

(22) PCT Filed: Feb. 23, 2005
(86) PCT No.: PCT/EP05/50766

§ 371 Date: Aug. 16, 2006

(51) Int. Cl. G06F 3/16

(52) U.S. Cl. 715/728; 715/810

(57) ABSTRACT

The invention relates to a method for selecting a list item from a selection list, especially in an automotive information or entertainment system, whereby optionally a search list item is input in a speech mode by speech input or in a manual input mode by manual input. According to the invention, in the speech input mode, the search list item is input as a spoken word and the spoken search list item is compared with the list items of the selection list. If there is sufficient agreement between the spoken search list item and at least one of the list items from the selection list, said at least one list item is selected as the search result. If there is not sufficient agreement between the spoken search list item and at least one of the list items of the selection list, the system automatically switches over to the manual input mode.

The invention relates to a method for selecting a list item from a selection list, in particular in an information or entertainment system in a motor vehicle, a list item which is sought either being input by means of a voice input in a voice input mode or being manually input in a manual input mode. The invention also relates to an information or entertainment system, especially in a motor vehicle, having a memory module for storing a multiplicity of list items, a manual input apparatus for manually inputting a list item sought, a voice input apparatus and a voice processing apparatus, a changeover module for changing over between a manual input mode and a voice input mode, and a selection module for selecting one of the list items using the list item which is sought and has been at least partially input using the manual input apparatus or the voice input apparatus.

The information or entertainment systems known and used in a motor vehicle are, for example, car radios, navigation systems, television receivers and multimedia systems. In this case, multimedia systems comprise a plurality of components, for example an audio system, a navigation system, a video system or a telephone hands-free device. In order to operate the information or entertainment systems in a motor vehicle, it is frequently necessary to select entries in a menu-like system or from a list. For example, the user of a motor vehicle navigation system must specify the desired destination at the beginning. For this purpose, it is generally necessary to input at least one statement of the location and usually also a statement of the street. In order to make a telephone call as well, the telephone number or the desired subscriber must first of all be selected from a list or input. This is currently usually effected using manual operating elements. For example, after the associated function has been requested, a virtual typewriter is inserted. The user uses one or more operating elements, for example a rotary/pushbutton controller or a twelve-key keypad, to input the initial letters of the city or street name sought or the name of the call partner sought. Different concepts have been developed in order to speed up the input operation. For example, only those letters which, in addition to the letters which have already been input, produce a character string for which there is a list item are offered for further input.

DE 101 20 691 A1 discloses a manual input apparatus which is used to further simplify the input operation. Said document describes an operating element in which a so-called “touchpad”, that is to say an arrangement having a touch-sensitive surface, is integrated. The touchpad is used to recognize handwriting so that the user can directly input letters or digits or other characters on the touchpad. A city name sought can therefore be written letter by letter in a simple manner. The movable operating element can then be used to select further functions. Such an input apparatus even requires a very low level of attention on the part of the operator and thus diverts his attention away from the traffic situation only to a slight extent.

In addition, voice input systems are generally known in the art. A voice recognition unit and the associated processing modules can be used to recognize a particular name and compare it with list items. However, the degree of recognition in such systems is not yet particularly high. This is due, on the one hand, to the different ways in which the different users speak but is also due to the fact that, when used in a motor vehicle, the noise level is generally relatively high. In addition, the large structured quantities of data to be stored and processed require powerful processors having a high storage and computing capacity. Therefore, extensive dialog strategies, for example, are required when used in a motor vehicle, the system asking the user, for example, in which area surrounding a large city the location sought is located. The advantages of rapid input which voice recognition systems per se afford are lost again as a result of such a dialog and relatively frequent failure of the search.

DE 197 17 601 A1, for example, describes a navigation method using voice input.

DE 199 14 631 A1 discloses a method for inputting letters and/or numbers to a driver information system, in which input may be effected using either a manual input apparatus or a voice input apparatus. The voice input of an entry sought is also effected character by character in this system, that is to say individual letters and/or numbers are spoken rather than complete words. In this case, the user can also change between manual input and voice input while inputting a single search term. However, the disadvantage of this is the requisite character-by-character voice input of the term sought.

Therefore, it is an object of the invention to specify a method for selecting a list item, which method gives rise to further simplified input and also, at the same time, improved interaction between the voice input mode and the manual input mode. Another object is to specify an information or entertainment system which likewise makes improved input possible.

The two objects are achieved by means of a method having the features of claim 1 and an information or entertainment system having the features of claim 7.

In this case, the invention combines a manual input mode for inputting the list item sought with a voice input mode in which the list item sought is input as a spoken word. In comparison with character-by-character input in the voice input mode, as is used in the known system, this results in the advantage of simplified voice input. An extensive dialog between the user and the system, as was mentioned at the outset for voice input systems having word-by-word voice input, is dispensed with in this case. If the spoken list item is not identified with sufficient accuracy or a corresponding entry is not found in the selection list, the invention automatically changes over to the manual input mode. In this manual input mode, the user can now input the first letters or digits of the list item sought and the search for the list item in the selection list is carried out using the characters which have been input. In situations in which at least one of the list items in the selection list can be assigned with sufficient accuracy to the voice input as a search result, the method according to the invention results in the list item sought being found in a rapid manner. If the list item sought is clearly identified in this case, the input method is concluded. If, for example, two similar list items are found, a short question for the user suffices to arrive at a clear result. If, in contrast, the desired list item is not identified on the basis of the voice input, a rapid transition to the input mode which is more suitable in this case is effected by automatically changing over to the manual input mode.

In this case, it is particularly preferable for the list item sought to be input letter by letter using a handwriting input apparatus in the manual input mode. Letter-by-letter input using a handwriting input apparatus, as disclosed, for example, in DE 101 20 691 A1 (mentioned at the outset), represents a fast possible way of manually inputting the list item sought. It is not necessary to laboriously select letters using a rotary and pushbutton controller or a keypad which usually has a plurality of letters in a motor vehicle. Word-by-word voice input in conjunction with a handwriting input apparatus in the automatic combination according to the invention constitutes a method for selecting a list item, which diverts the driver's attention away from the traffic situation only to a very slight extent. In this case, the handwriting recognition apparatus has a touch-sensitive surface which is preferably integrated in a rotary controller or else, in the form of a so-called “touchscreen”, is part of an optical output apparatus.

One particular embodiment provides for optical or acoustic feedback after each letter has been input using the handwriting input apparatus. Therefore, the user can monitor, in a simple manner, whether the character which he has input has been correctly recognized. In this case, letters and digits, in particular, are possible as characters.

One special refinement of the method provides for a character string which has already been manually input to be automatically compared with the list items in the selection list and for the number M of list items containing the input character string as an initial part to be determined. The system also determines whether the number M is less than a prescribed value X and greater than 1; if the latter case is true, the list items containing the input character string as an initial part are offered for selection on an optical display apparatus. Additionally or alternatively, the system changes over to the voice input mode.

The number M may be, for example, the number of lines which can be displayed on a display apparatus. In this case, the user can then simply select one of the list items displayed, for example using a rotary/pushbutton controller.

Alternatively, the system changes over to the voice input mode if the number M of list items which are still possible is less than the prescribed value. In this case, the prescribed value is, for example, the maximum vocabulary of the voice recognition apparatus. The system changes over to the voice input mode only when the maximum vocabulary of the voice recognition apparatus is greater than or equal to the number of selection options which are still available. The user is then requested to input the list item sought by means of voice input. On account of the then only relatively small number of list items which are still possible, the probability of recognition is greater and a voice recognition system having a relatively small capacity can be used. This is especially advantageous for use in motor vehicles from the point of view of costs.

Another embodiment of the invention provides for the spoken word to be stored as a voice input signal before the system automatically changes over from the voice input mode to the manual input mode. This refinement of the invention makes it possible for the spoken word to be used again at any time at a later stage of input. In particular, provision is made for the stored voice input signal to be compared with those list items in the selection list whose initial part corresponds to the character string which has been manually input if the number of list items determined in this manner is less than a prescribed value S. Given sufficient correspondence to one of the list items in the selection list, this list item is selected and an indication of the selection is optically or acoustically output. Given a sufficiently small number of list items which are still possible, this method variant makes it possible to dispense with the further manual input of additional characters or renewed voice input and to rapidly find the list item sought.

One refinement of the information or entertainment system provides for it to be or contain a navigation system and for the list items to be statements of the location. Another variant provides for the information or entertainment system to be or contain an audio and/or video system and for the list items to be transmitter frequencies or transmitter names or telephone numbers or music or video titles. A multiplicity of list items frequently occur in said applications or categories, in particular, so that an efficient selection method is especially required in this case.

The method according to the invention is not restricted to use in motor vehicles. Rather it can also be used, in particular, in information systems for timetables or flight schedules or for public transport tickets or for tourist information. Uses in information systems for banks and the like are also possible as another field of use.

In the manual input mode, input may be effected in writing or else using a keypad, for example also using a touchscreen or a possibly virtual keypad which is similar to typewriters.

The invention will be described below with reference to an exemplary embodiment. In the drawings:

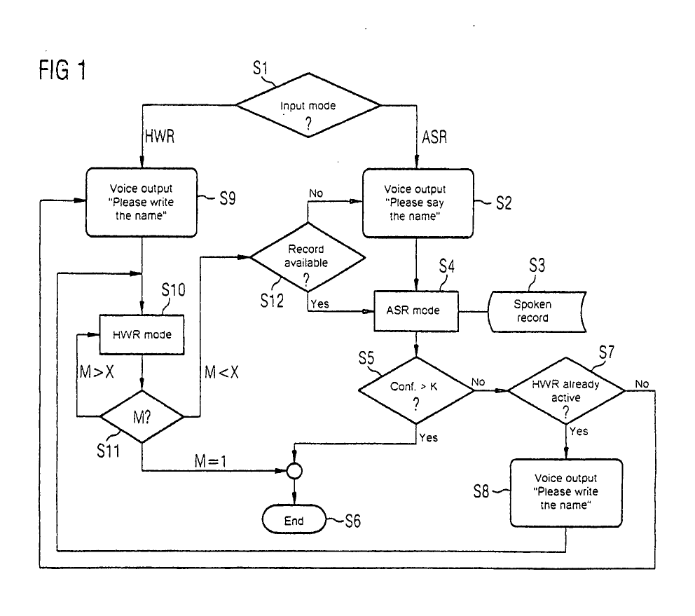

FIG. 1: shows a flowchart of the method according to the invention,

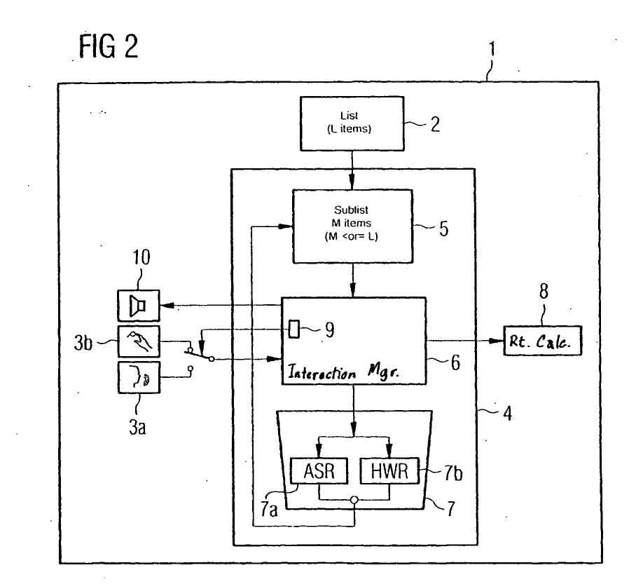

FIG. 2: shows the fundamental system components of an information or entertainment system according to the invention.

FIG. 1 shows a flowchart of a method sequence according to the invention. In step S1, the user initiates the operation of searching for either the handwritten input or a voice input. If the user has decided on voice input, he is requested, in step S2, to say the list item sought. In step S3, the user says the list item sought, the spoken word being used as an input signal. In step S4, the voice processing apparatus is activated, the spoken word being compared with the list items in a manner known per se. In this case, correspondence between the spoken word and one or more list items is respectively determined using a confidence level. This confidence level is compared with a prescribed value K in step S5. If the confidence level is greater than the prescribed value, that is to say there is sufficient correspondence between the spoken list item sought and one of the list items from the selection list, the list item sought has already been clearly found and the input method is concluded in step S6.

If, in contrast, step S5 determines that there is no sufficient correspondence between the spoken list item sought and one of the list items from the selection list, step S7 checks whether the handwriting recognition apparatus has already been activated. If this is not the case, the handwriting recognition apparatus is activated in step S9 and the user is requested to input the list item sought into the handwriting recognition apparatus. If, in contrast, step S7 determines that the handwriting recognition apparatus has already been activated, although the user is likewise requested to manually input the list item sought in step S8, activation of the handwriting recognition apparatus can then be omitted. In both cases, input in the handwriting input mode is continued in step S10.

In step S10, the user then inputs the list item sought letter by letter into the handwriting recognition apparatus. The number of list items which are still possible is reduced as each letter is input. After each character has been input, step S11 determines the number of these list items which are still possible and compares said number with a prescribed value. If the number of possible list items is still greater than this prescribed value, further letters must continue to be input in step S10.

If step S11 determines that there is only one possible list item available, this list item is the list item sought and the input method is concluded in step S6.

If step S11 determines that the number of list items which are still possible is less than the prescribed value X, which corresponds to the maximum vocabulary of the voice recognition apparatus in this case, step S12 checks whether the list item sought has already been input by means of voice input and stored. If step S12 determines that such a data record is available, step S4 in the voice mode checks whether the search term which has been input by means of voice input corresponds to one of the list items which are still possible. For this purpose, step S5 again determines a confidence level in the manner which has already been described above and, depending on whether one of the list items which are still possible can be identified with sufficient correspondence, the input method is concluded in step S6 or the system changes to the manual input mode again in step S7.

If step S12 determines that no voice signal has been stored, which is the case, in particular, when the process has begun with the handwriting input mode rather than the voice input mode, the request to input the list item sought by means of voice input is made in step S2. The method is then continued in step S4 in the manner described above, the already restricted subset of list items which are still possible on the basis of the handwritten input again being used as a basis.

The method has been described beginning with a voice input. If, however, the user does not decide, in step S1, to begin with voice input, he is requested, in step S9, to input the list item sought using the handwriting input apparatus. The subsequent method then takes place as described above for the handwritten input after the system has changed over from the voice input mode.

FIG. 2 shows the fundamental elements of an information or entertainment system in a motor vehicle provided that they are important for selecting a list item. In this case, specific elements of the respective information or entertainment system are not shown since they are sufficiently well known to a person skilled in the art. For example, a navigation system contains means for determining the position, means for calculating the route and means for outputting driving instructions to a user.

The information or entertainment system 1 illustrated in FIG. 2 has a voice input apparatus 3a and a manual input apparatus 3b as input means. The manual input apparatus 3b has a touch-sensitive surface and is in the form of a handwriting recognition apparatus. At least one list having a plurality of list items is stored in a memory module 2. In the case of the exemplary embodiment, the memory module contains list items containing the names of locations for a navigation system. A copy or subset of the list which is stored in the memory module 2 is buffer-stored in a further memory element 5. An interaction manager 6 which is essentially in the form of a computer program processes the input signals coming from the voice input apparatus 3a and the handwriting input apparatus 3b and uses the changeover module 9 to control changeover between the handwriting input mode and the voice input mode, as was described above in connection with FIG. 1. The interaction manager 6 also controls the output of acoustic feedback via the acoustic output unit 10.

Finally, the interaction manager 6 also forwards a list item found to the further components of the information or entertainment system 1, to a route calculation module 8 of a navigation system in the exemplary embodiment shown in FIG. 2. As already mentioned above, the further components of such a navigation system are known per se and are not indicated further in FIG. 2.

The interaction manager 6 is connected to a filter module 7 having a voice processing module 7a and a handwriting processing module 7b. In the filter module 7, the list items in the selection list are filtered using the list item which is sought and has been input using the voice input apparatus 3a or the manual input apparatus 3b. As described above in connection with FIG. 1, the number of possible list items is filtered out from the full set of list items in the selection list using a character string, which has already been input, for example, and is stored in the memory element 5. At the beginning of a search method, the memory element 5 thus generally contains a complete temporary copy of the complete selection list but, as the search term is increasingly narrowed down by inputting a character string, contains only a subset of the selection list. The voice processing module 7a and the handwriting processing module 7b are each known per se.

The invention further simplifies the selection of a list item from a selection list, in particular in an information or entertainment system in a motor vehicle, and minimizes the distraction of the driver from the traveling situation, the advantages of a simplified voice input mode and a handwriting recognition mode having been combined.

1.-15. (canceled)

16. A method for selecting a list item from a selection list comprising a plurality of list items in a system having a voice input device for receiving a voice input in a voice input mode and a manual input device for receiving a manual input in a manual input mode, said method comprising the steps of:
inputting a desired list item to the system as a voice input in the voice input mode;
comparing the voice input with the plurality of list items in the selection list;
selecting one list item from the selection list if the one list item has at least a minimum correspondence with the spoken word;
automatically changing over to the manual input mode if none of the plurality of list items in the selection list have at least the minimum correspondence with the spoken word and storing the voice input before said step of automatically changing;
manually inputting an input character string in the manual input mode after said step of automatically changing;
determining matching ones of the plurality of list items in the selection list having an initial part corresponding to the input character string and comparing the stored voice input to the matching ones of the plurality of list items if the amount of matching ones of the plurality of list items is less than a predetermined amount;
selecting one list item from the matching ones of the plurality of list items in the selection list if the one list item has at least a predetermined correspondence with the voice input; and
outputting an indication of the selected one list item from the selection list or the selected one list item from the matching one of the plurality of list items optically or acoustically.

17. The method of claim 16, wherein said step of inputting an input character string comprises inputting the input character string character by character using a handwriting input apparatus or a keypad in the manual input mode.

18. The method of claim 17, wherein said step of inputting character by character further comprises the step of providing an optical or acoustic feedback after each character has been input.

19. The method of claim 16, wherein said step of determining matching ones comprises automatically comparing the character string that has been manually input to the plurality of list items in the selection list, determining the number M of list items containing the input character string as an initial part, determining whether the number M is less than a prescribed value X and greater than 1, and at least one of offering the list items containing the input character string as an initial part for selection on an optical display apparatus or changing over to the voice input mode if it is determined that the number M is less than a prescribed value X and greater than 1.

20. An information or entertainment system, comprising:
a memory module storing a plurality of list items;
a manual input apparatus for receiving a manual input indicating a desired list item;
a voice input apparatus and a voice processing apparatus for receiving a voice input indicating the desired list item, said voice processing apparatus processing spoken words;
a selection module selecting one of the plurality of list items based on the voice input or the manual input and having a changeover module arranged and dimensioned for manually and automatically changing between the manual input mode and the voice input mode, said selection module further comprising
means for storing the voice input before automatically changing over to the manual input mode,
means for comparing the stored voice input with those list items in the selection list whose initial part corresponds to the character string which has been manually input if the number of list items determined in this manner is less than a prescribed value, and
means for selecting a list item from those list items in the selection list whose initial part corresponds to the character string which has been manually input if the correspondence of the list item to the stored voice input is greater than a minimum correspondence; and
an output device providing one of an optical or acoustic indication of the selection.

21. The information or entertainment system of claim 20, wherein said manual input apparatus is a handwriting recognition apparatus.

22. The information or entertainment system of claim 20, wherein said manual input apparatus has a touch-sensitive surface.

23. The information or entertainment system of claim 22, further comprising a rotary controller, wherein said touch-sensitive surface is integrated in said rotary controller.

24. The information or entertainment system of claim 22, further comprising a display apparatus, wherein said touch-sensitive surface comprises a touchscreen integrated in said display apparatus.

25. The information or entertainment system of claim 20, wherein said information or entertainment system comprises a navigation system and each of said plurality of list items indicates a location.

26. The information or entertainment system of claim 20, wherein said information or entertainment system comprises at least one of an audio and video system and each of said plurality of list items indicates one of a transmitter frequency, a transmitter name, a telephone number, or a music or video title.

27. The information or entertainment system of claim 20, wherein said information or entertainment system comprises an information system for public transport or for tourists.

28. The information or entertainment system of claim 20, wherein said information or entertainment system comprises a bank information system.
